(19) United States
(12) Patent Application Publication
(10) Pub. No.: US 2015/0066740 A1
(43) Pub. Date: Mar. 5, 2015

(54) System and Method of Electronic Exchange for Residential Mortgages

(71) Applicant: LTVtrade, Huntington Beach, CA (US)

(72) Inventor: Dean DiCarlo, Huntington Beach, CA (US)

(21) Appl. No.: 14/479,849

(22) Filed: Sep. 8, 2014

Related U.S. Application Data
(63) Continuation-in-part of application No. 13/289,573, filed on Nov. 4, 2011.
(60) Provisional application No. 61/410,526, filed on Nov. 5, 2010.

(51) Int. Cl. G06Q 40/02

(52) U.S. Cl. CPC G06Q 40/025
USPC 705/38

(57) ABSTRACT

A method and system for providing anonymous credit qualification and price negotiation, comprising: receiving, at a server computer, at least one application for at least one borrower, the at least one application comprising qualification data relating to the at least one borrower, supplementing the at least one application with third-party data relating to the at least one borrower, creating, for each of the at least one borrower, a complete borrower profile comprising information relating to each of the at least one borrower, and creating, for each of the at least one borrower, a universal borrower profile, wherein the Universal Borrower Profile comprises anonymous information selected from the complete borrower profile associated with each of the at least one borrower.

### CROSS REFERENCE TO RELATED APPLICATIONS

This application is a Continuation-in-Part of U.S. patent application Ser. No. 13/289,573, filed Nov. 4, 2011, which claims the priority of U.S. Provisional Patent Application No. 61/410,526, filed Nov. 5, 2010, which are hereby incorporated by reference herein in their entirety.

### BACKGROUND OF THE INVENTION

1. Field of the Invention

The present invention relates generally to an exchange system and method for managing a marketplace to buy and sell financial products and, more particularly, to an exchange system and method for trading whole loans on the secondary market.

2. Description of Related Art

In a secondary market, loans are exchanged between lenders and investors. Such loans include consumer loan products that are traditional primary residence mortgage loans to consumers. After lenders make loans to consumers, they often try to sell the loan to a mortgage banker. Often, lenders “bulk” sale loans to investors (e.g., mortgage bankers), meaning that those lenders sell several loans (loan pools) at once.

Investors buy loan pools from the loan origination (e.g., mortgage bank) or lender, and then pool the assets in such a way as to make them attractive to other investors. Large institutional investors, such as Freddie Mac, insurance companies, large hedge funds, bond funds, and pension funds, buy closed mortgage loans in pools.

The loan pools can be securitized and sold to other investors as mortgage-backed securities. The investors may group several pools of loans together into a larger pool, and use the loans collectively as collateral to back securities (i.e., mortgage-backed securities, such as bonds). Typically, these groups of loan pools are valued in the range of $50 million to $1 billion. Because the companies that purchase the loan pools and use them to back securities are personally responsible, there is a great deal of risk involved in these types of transactions. These larger pools can then be offered for sale to buyers on the secondary market. The pools may be comprised of different asset classes mixed together, making it risky for an inventor trying to buy a particular class. For example, non-conforming loans, such as sub-prime mortgages, can be mixed in a loan pool with conforming loans. Traditionally, a pool would be purchased as a whole, forcing investors to purchase some assets they may have little interest in and increasing their overall investment risk.

Recently, large loan pools have been separated and marketed as smaller pools of mortgages in order for small and mid-sized investment institutions to participate in the market. However, participation in the secondary loan market is complicated and often involves atypical trading methods due to the pooled nature of the loans. Further, trading platforms for these smaller pools of loans are often difficult to use and offer little functionality typical of institutional trading methods and fail to operate with commodity-like efficiency.

Institutionalized selling of loan pools does not address the separate risks of individual closed loans. Loan pools can group individual loans that have similar risk characteristics or completely different risk characteristics, but the pool itself is sold as a single investment, with a single average risk characteristic, leaving little or no transparency as to the risk of the individual loans within the pool. As a result, an investor is unable to screen individual loans and make purchasing decisions based on the risk-level of an individual loan. Furthermore, individual closed loans tend to be illiquid trading instruments. Not surprisingly then, most buying and selling of closed loans is accomplished through private deals between buyers and sellers.

Many investors previously content with purchasing loans in the aggregate now recognize the need to scrutinize their debt instrument investments on a loan-by-loan basis, possibly building their own loan pools through individual purchases. However, existing trade exchanges are not structured to support such transactions, nor can limited private networks efficiently accommodate the new demand. Therefore, there exists a need in the financial industry for an efficient trading system to facilitate the buying and selling of individual closed loans, especially closed residential mortgage loans.

What is needed is a comprehensive, transparent, and user friendly trading platform to offer functionality that embraces typical institutional trading methods, yet operates with a commodity-like efficiency only possible when transacting individual whole loans.

Additionally, a borrower's ability to quickly and easily shop for credit and financing among multiple lenders is significantly limited by a process that is traditionally dependent on thorough underwriting requiring borrowers to share massive amounts of highly sensitive personal data and documentation in a non-standardized underwriting process. Findings can take days to receive firm offers and since interest rates are part of a fluid marketplace that can change drastically from hour to hour, it is difficult to compare loan terms among different lenders without having fluctuations from when the offer is created. If a borrower desires to get multiple offers, they must submit themselves to an underwriting process among several lenders. Because loan officers are salespeople, borrowers are now subjected to correspondence with multiple salespeople, all who are working to convince the borrower to take their offer. For the foregoing reasons, it is no surprise that a recent survey conducted by Fannie Mae indicated that almost half of all borrowers only meet with one lender and they take the only offer they receive.

Moreover, without a means to make lenders accountable for rates posted online, borrowers attempting to find the best credit terms online is not a reliable method in its current form and frustrated borrowers often time find themselves subjected to bait-and-switch rates and terms.

### SUMMARY OF THE INVENTION

It is the object of this invention to provide a system and method for providing a user friendly trading platform for sellers and bidders which embraces typical institutional trading methods and operates with the efficiency that is only possible when transacting individual, whole loans.

It is a further object of this invention to create a process and an environment where borrowers can subject themselves to a single underwriting where their salient qualification information can be discovered and shared with prospective lenders anonymously to receive firm offers in a very short amount of time.

According to one aspect of the present invention, there is provided a method for trading individual, whole loans in an open-market forum, comprising: receiving, from at least one seller, a request to sell at least one pool of loans, wherein the at least one pool of loans comprises at least one whole loan; selecting documentation data relating to the at least one pool of loans; determining, based on the documentation data, an estimated tradable range for the at least one whole loan of the at least one pool of loans; inputting, to at least one database connected to at least one server computer, listing data relating to the at least one whole loan of the at least one pool of loans, wherein the listing data comprises at least the estimated tradable range; receiving, from the at least one seller, approval to proceed with an auction to sell the at least one whole loan of the at least one pool of loans; providing, to at least one user through an Internet website, the listing data relating to the at least one whole loan of the at least one pool of loans; and receiving, from at least one user through an Internet website, bids for the at least one whole loan of the at least one pool of loans.

According to another aspect of the present invention, there is provided an exchange system for trading individual, whole loans in an online marketplace, comprising: communication means for acquiring, from at least one seller, at least one request to sell at least one pool of loans, wherein the at least one pool of loans comprises at least one whole loan; data gathering means for acquiring documentation data relating to the at least one whole loan; a server computer system having at least one processor and at least one data storage unit, wherein the server computer is connected to at least one public or private network, the server computer configured to: receive data representing an estimated tradable range for the at least one whole loan, wherein the estimated tradable range is calculated from the documentation data; transmit, to the at least one seller, the data representing an estimated tradable range; receive, from the at least one seller, an approval to proceed with sale of the at least one pool of loans; make available to remote bidders, through the at least one public or private network, listing data comprising data relating to the at least one whole loan; receive, from at least one remote bidder, at least one bid for at least one whole loan; and determine, for each of the at least one whole loan, a winning bidder based on the at least one bid received from the at least one remote bidder.

According to another aspect of the present invention, there is provided a method for providing anonymous credit qualification and price negotiation, the method comprising: receiving, at a server computer, at least one application for at least one borrower, the at least one application comprising qualification data relating to the at least one borrower; supplementing the at least one application with third party data relating to the at least one borrower; creating, for each of the at least one borrower, a complete borrower profile comprising information relating to each of the at least one borrower; and creating, for each of the at least one borrower, a universal borrower profile, wherein the universal borrower profile comprises anonymous information selected from the complete borrower profile associated with each of the at least one borrower.

### BRIEF DESCRIPTION OF THE DRAWINGS

FIG. 1 illustrates an embodiment of the exchange system of the present invention;

FIG. 2 illustrates a flow diagram for listing items of the exchange system of the present invention;

FIG. 3 illustrates a flow diagram for the sales process of the exchange system of the present invention;

FIG. 4 illustrates a flow diagram for the registration process of the exchange system of the present invention;

FIG. 5 illustrates a flow diagram for the buyer process of the exchange system of the present invention;

FIGS. 6A and 6B illustrates user interfaces for the exchange system of the present invention;

FIG. 7A illustrates a flow diagram for the loan realignment service sale of the exchange system of the present invention;

FIG. 7B illustrates a flow diagram for the loan realignment service sale of the exchange system of the present invention;

FIG. 7C illustrates a flow diagram for the loan realignment service sale of the exchange system of the present invention;

FIG. 8 illustrates a user interface for the debt marketplace of the present invention;

FIG. 9 illustrates a flow diagram for the origination execution system of the present invention;

FIG. 10 illustrates a flow diagram for the anonymous debt marketplace of the present invention; and

FIG. 11 illustrates a block diagram of the computer system of the present invention.

### DESCRIPTION OF THE PREFERRED EMBODIMENTS

The present invention provides systems and methods for providing a user friendly trading platform for sellers and bidders which embraces typical institutional trading methods and operates with an efficiency that is only possible when transacting individual, whole loans.

In a preferred, but non-limiting embodiment, the system provides a fully transparent auction with firm bids from buyers that have a deposit account. Exchange participants can efficiently and quickly settle transactions. Sellers can provide pools of loans and use exchange services to provide auction information a bidder uses to make determinations about such assets. The exchange system provides standardized Purchase & Sales agreements for sellers, but also has the flexibility to allow the market to create new versions to be used in trading. In all embodiments, the exchange system provides flexibility for separating pools of whole loans for bidders to analyze and select only the loan or loans that meet their bid requirements. One skilled in the art will appreciate that the system and method of the present invention is not limited to whole loans, as other types of financial instruments, assets, and debt instruments could benefit equally from the present invention. Since debt instruments typically trade on the secondary market in pools, the present invention can achieve higher prices for sellers and more preferred assets for buyers when buyers can buy targeted amounts of assets that best fit in their investment strategy. Such instruments may include, but are not limited to, auto loans, credit card debt, commercial real estate loans, boat loans, insurance contracts, etc. The system removes inefficiencies from the traditional system as the items can converge on a price indicative of their value, and the value encompasses the needs of a broad spectrum of buyers. The platform (system) can accommodate the unique attributes inherent in each asset class by utilizing a flexible and extensible database schema.

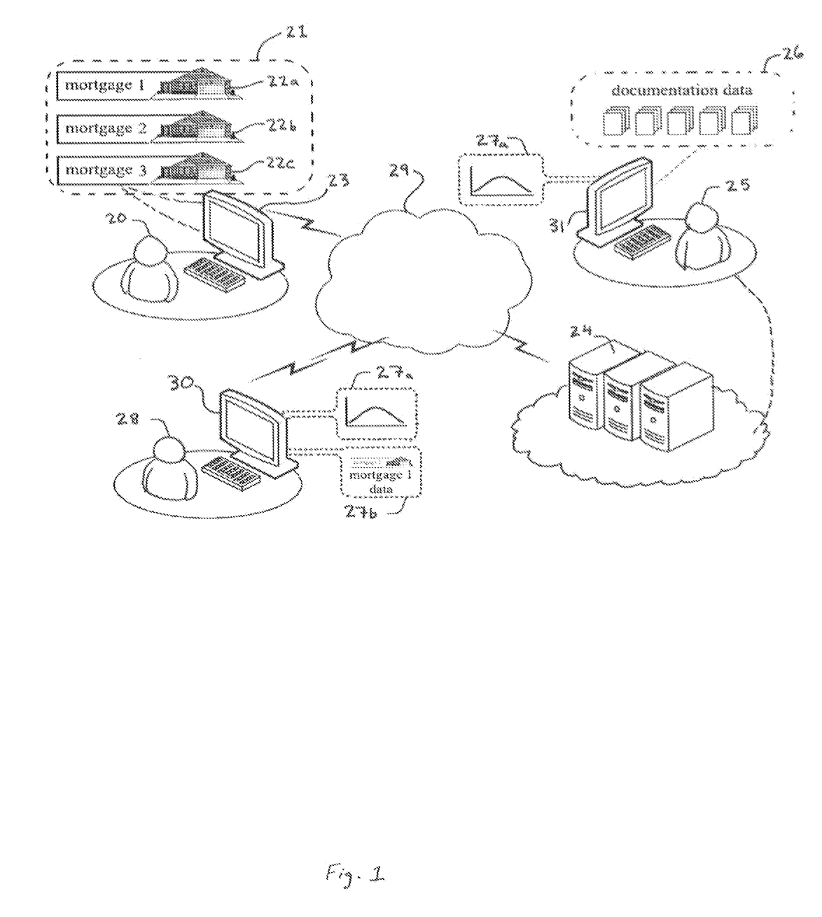

With reference to FIG. 1, a system is shown for facilitating an electronic exchange for residential mortgages. A seller 20 having a pool of mortgages 21 communicates with the exchange entity through communications means, such as a computer 23 connected to the Internet 29. It will be appreciated that any number of communications means may be utilized, including, but not limited to, telephones, cell phones, mobile applications, in-person transactions, Application Programming Interfaces (API), web based services, and written transactions. Each pool of debt instruments (in this example, mortgage loans 21) comprises at least one whole, individual loan 22a and, in a preferred, but non-limiting embodiment, each pool of loans 21 comprises a plurality of individual, whole loans 22a, 22b, 22c.

With continuing reference to FIG. 1, a representative (or agent) 25 associated with the exchange entity reviews each whole, individual mortgage loan 22a, 22b, 22c in each pool of mortgages 21. The agent 25 of the exchange entity then selects or obtains documentation data 26 relating to each whole, individual mortgage loan 22a, 22b, 22c. It will be appreciated that the agent 25 may be a human being, an automated process or software module, or any other device or system for making queries relating to mortgage loan information. The documentation data 26 may be selected from a local compilation of data stored in a database associated with the exchange entity, or it may be selected from various other sources from the Internet 29 or elsewhere. Further, the documentation data 26 may be gathered via data gathering means, which may include, but is not limited to, an automated program configured to search public and/or private databases for information relating to each loan or pool of loans, a person or team of people organized to gather information, or a combination of computer-implemented search functionalities and people. Further, such data gathering means may be in the form of a special purpose computer comprising computer components and program instructions containing an algorithm to search public and/or private databases for information based on keywords, loan information, or any other relevant data, and to parse such information and/or data to find relevant portions. Loan documentation data may be stored in a local database or file storage, or stored and maintained by a third-party provider.

Once the agent 25 identifies the relevant documentation data 26 for each whole, individual loan 22a, 22b, 22c, that data is transmitted to the exchange entity's server computer 24, where it is stored on a data storage unit or device, such as a hard disk drive. The relevant documentation data may be inputted via an input means, such as a computer system 31 associated with the agent 25 of the exchange entity. The server computer 24 is in communication with the Internet 29 and, in a preferred, but non-limiting embodiment, has a public Internet Protocol (IP) address and is running a web server platform (HTTP server). In an additional, but non-limiting embodiment, communication may occur over a private network, including, but not limited to, a virtual private network utilizing industry standard communication software and protocols. The relevant documentation data 26 may take a variety of forms, such as visual displays 27a, 27b of analytical or reference data, or textual data.

After the relevant documentation data 26 has been transmitted to the server computer 24, along with other information relating to the mortgage loan pools 21 and the whole, individual mortgage loans 22a, 22b, 22c in that pool, the seller 20 is given the opportunity to approve of the listing. The approval process may be made with any number of communications means, including, but not limited to, a telephone, cell phone, mobile communications device, or a computer 23 connected to the Internet 29 or other network.

Once the seller 20 of the pool of mortgage loans 21 approves of the listing, the server computer 24 hosts an auction by providing HTTP contents, or other forms of data, to potential bidders 28 through the Internet 29 or other network. The bidders 28, through a website or other form of interface with the server computer 24, are able to view analytical and/or informational data 27a, 27b relating to individual, whole mortgage loans 22a, 22b, 22c, as well as mortgage loan pools 21 containing such loans. Through the interface, or other communication methods, bidders 28 can specify their bids in their preferred format, which may include disparate bidding methods and non-monetary bidding methods, described herein.

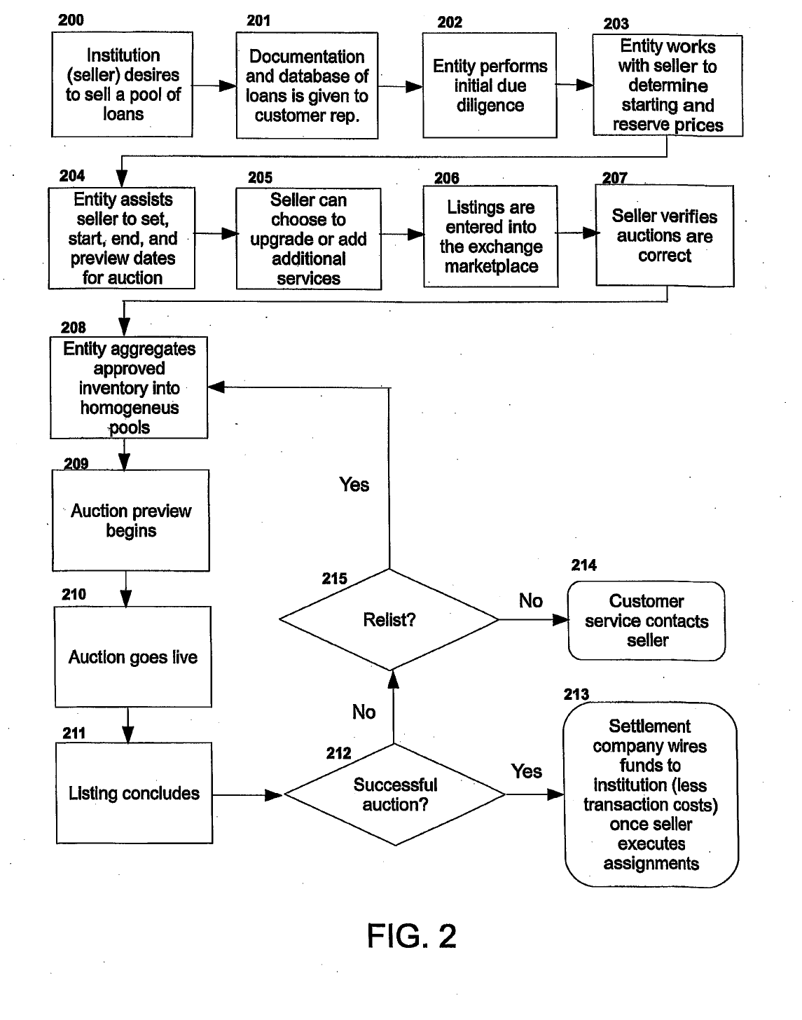

With reference to FIG. 2, a typical scenario for selling whole loans begins at step 200 when a listing institution (lender or seller 20) desires to sell a pool of loans. At step 201, a database of loans to be sold, along with documentation data relating to the loans, is given to the customer representative 25 at the exchange. The exchange entity may then perform initial due diligence at step 202. At step 203, the customer representative 25 communicates with the seller 20 and together they set an opening price and a reserve price. Customer representatives 25 also work with sellers 20 at step 204 to set the auction start, end, and preview dates. The seller 20 is given the opportunity to select all bidders that will be exposed to the assets they intend to sell by creating a subset of bidders from the entire universe of qualified bidders approved by the marketplace to transact. At step 205, the seller 20 can choose to either upgrade each asset listing, or to add additional services, such as photos, Broker's Price Opinion (BPO) appraisal, or other services. Next, at step 206, the assets are entered into the exchange system (possibly on a data storage unit of a server computer 24) and, at step 207, the seller 20 verifies that the auction information is correct. The exchange entity may then aggregate the approved inventory into pools, which is dictated by the Purchase and Sale agreement to be used in the transaction, which is selected by the seller 20. At step 209, after the listing and authorization activities are concluded, a preview period begins on a specified date where authorized potential buyers can view and research the auction assets. After the preview period is completed, and, at step 210, the exchange entity conducts the auction through a website (via one or more web servers 24), interactive portal, web based service, API, or other communication means configured to accept bids. Bidders 28 are able to bid on the listings from their computers. When the auction goes live, web content for facilitating users' participation in the auction are made available to individual bidders (users) 28, either privately (i.e., requiring a registration, membership in specific marketplace user groups, or login) or publicly. Later, at step 211, after the auction goes live, the listing process ends. At step 212, if the auction was successful, the assets are exchanged for payment between the seller 20 and bidder 28, and then, at step 213, the settlement company wires the funds to the institution and the assignment is executed. The exchange system can optionally relist unsold listings (step 215); the seller 20 can relist the property using the same procedure.

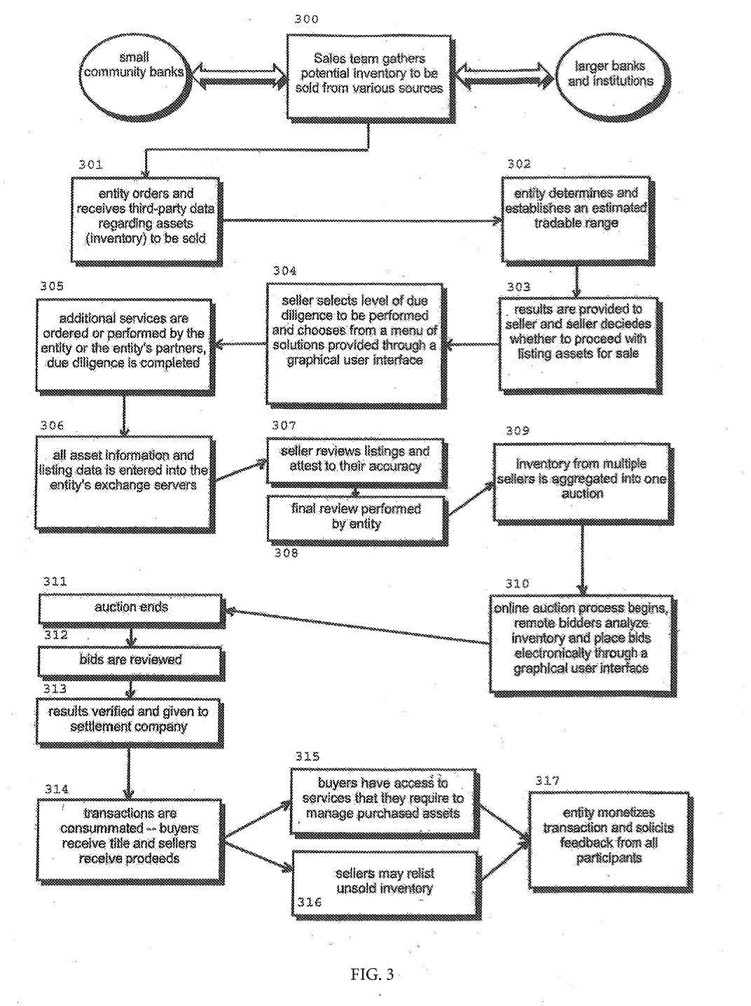

With reference to FIG. 3, the sales process is outlined in detail. During the sales process, the exchange operator (e.g., sales team, or an automated data gathering process), or other individual(s) or entity(ies), gathers potential inventory from multiple sources to be sold on the exchange to various potential buyers (investors). Next, at step 301, exchange operators gather and analyze a base level of due diligence data regarding the assets to be sold. As an example, third party data 26 is gathered electronically with the use of a software program or module running on a computer 31 that is programmed with an algorithm for gathering data relevant to mortgage loans or other types of loans. At step 302, exchange operators then use the due diligence and additional third party data 26 to establish an estimated tradable range for the asset. At step 303, these results are shared with the seller 20, possibly though a communications means such as an Internet 29 webpage, who, based on this information, can determine whether to proceed in listing the asset. If the seller 20 determines they would like to proceed with the sale, then, at step 305, the seller 20 can select an optional enhanced level of due diligence to be performed on the sale by the exchange operator or other individual. At this point in the exchange, initiation services can be provided to the seller 20, including services from vendors that partner with the exchange 32. These various services may be selectable through a menu and/or graphical user interface provided to the seller 20 through a communications means, such as an Internet 29 webpage.

One service provided by the exchange system is due diligence. Due diligence is performed on each loan in the system, and the exchange system can give indication notification, such as by using a “certified” status. During this step, the exchange system operators are involved to make sure that the financial products are characterized correctly. This step can provide assurance to the bidder 28 and/or seller 20 that the loans and information describing the loans are accurate.

Due diligence can provide analytical information regarding the borrower quality, collateral quality, and submarket data. The borrower quality may include analysis of information that includes, but is not limited to, an updated credit score, 12-month mortgage payment history, borrower's age disclosure, and underwriting fraud review. The collateral quality and characteristics may include analysis of information that includes, but is not limited to, the current property value, list of current liens and priority, flood zone determination, homeowner's insurance coverage status, property collateral characteristics, property condition report and pictures, Notice of Default (NOD)/Notice of Trustee Sale (NTS) filing disclosure, and property/borrower litigation disclosure. Metropolitan Statistical Area (MSA) and submarket data may include analysis of information including, but not limited to, local foreclosure data, local market information (projected growth rates), and local school information. This analytical information may be displayed as lists, charts, graphs, maps, or in other ways. Another service that may be provided is to standardize the representation and manner of dissemination of due diligence results and data provided by the seller 20 that describes the borrower, collateral and note terms so that market participants can more efficiently receive and act on the information. Many buyers organize their data in different formats, which can make bidders 28 review more difficult (e.g., interest rate may be called “INT RATE” or “Rate” and may be represented as 6.50% or 0.065).

The inventory of loans, along with the due diligence findings, may then be posted or otherwise made available to the widest pool of potential bidders, including all institutions and local bidders 28 that are authorized to view the asset class, unless the seller 20 chooses to narrow the audience to a smaller subset.

With continued reference to FIG. 3, once the due diligence process is completed, the asset information and listing data is entered into the trade exchange server 24 at step 306. The exchange system can provide a view where a seller 20 can preview the asset information and listing data from a remote computer 23 that has authenticated into the system. At step 307, the seller 20 may review the listings and can determine their accuracy, and a final review may be performed by the exchange entity. The system provides a mechanism to indicate a complete listing. At step 308, once a final review by the seller 20 is completed, the exchange system can perform an additional review to determine the accuracy of the listings. At step 309, the trade exchange servers 24 can include inventory from one or more sellers 20, which may be aggregated into one auction. The information may be stored in a database system as discussed below.

With continued reference to FIG. 3, at step 310, after the seller 20 has completed the process for listing, the exchange operators can initiate an auction once the seller 20 selects a standardized version of the purchase and sale contract to be used for the sale. Before a potential buyer can place a bid on an auction, they must first be an approved user of the exchange and have permission to view both the auction and the asset class related to the auction asset(s). Bidders 28 are interested parties and may include a variety of different people and entities, ranging from large and mid-sized financial institutions to individual brokers or accredited investors who desire to build a financial portfolio and possibly service whole loans themselves. In addition, bidders 28 may be service firms that can use the system to modify the mortgages associated to the listing, or provide loans to borrowers.

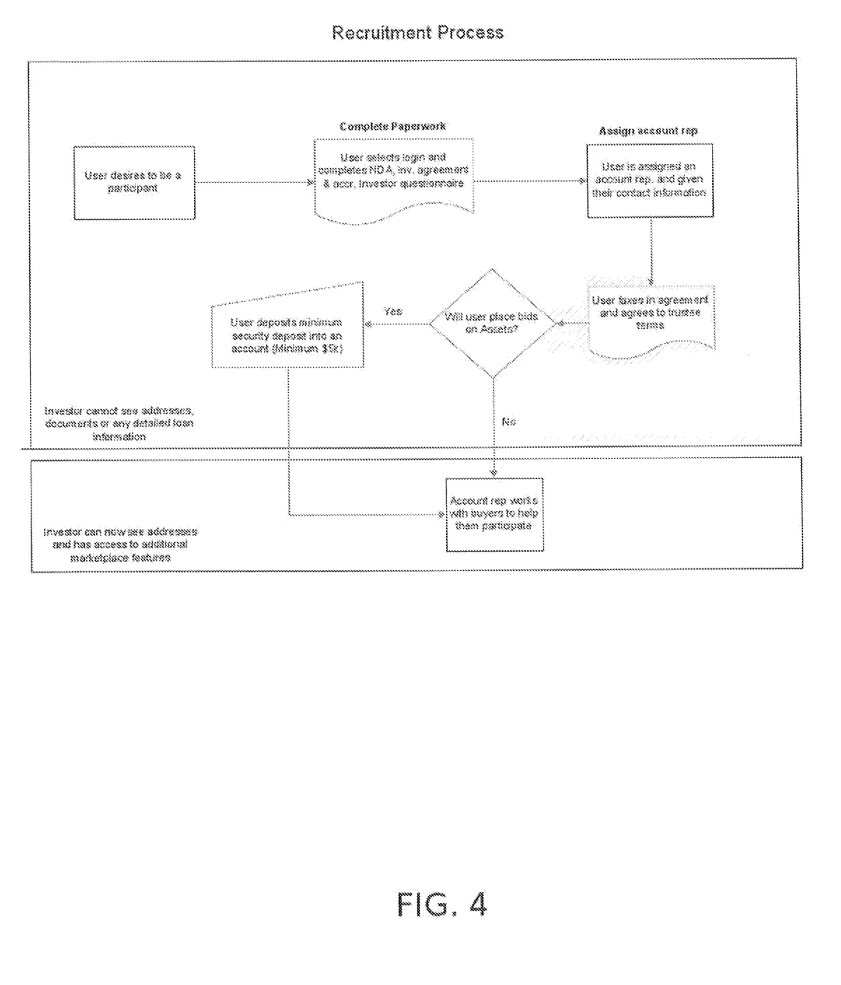

Referring now to FIG. 4, a registration process is outlined according to the principles of the present invention. The registration process may be programmed on exchange system servers 24 and controls the authorization of users in the system. In a preferred, but non-limiting embodiment, in order for a buyer 28 to participate in the auction, the registration process must be completed, which requires that investors 28 create a user account having a login and complete a Non-Disclosure Agreement (NDA), investor agreement, and investor questionnaire. Investors 28 may also be assigned an account representative and may be required to complete an agreement and agree to trustee terms, and then deposit funds into an account meeting a minimum requirement (e.g., $5,000.00). Buying/bidding power through the marketplace is determined by the amount an investor has on account multiplied by the margin afforded the investor. For example, an investor working on a 5% margin account could place bids totaling $100,000 off of a $5,000 deposit. In a preferred, but non-limiting embodiment, investors 28 cannot see addresses, documents, or any other detailed loan information until the registration process is completed. An account representative may work with the investor to help them become a buyer in the exchange. It will be appreciated that the present invention may utilize many different types and/or forms for a registration process for buyers/investors 28 and other auction participants. For a seller 20 to list assets for auction, similar user registration process steps may be followed, although the investor agreement may have different legal, compliance, and financial requirements. Sellers 20 may not be required to place funds in an escrow account.

With continued reference to FIG. 3, as an auction begins, bidders 28 analyze the listings, examine the inventory, and place bids according to their preferences electronically via the exchange system. In a preferred, but non-limiting embodiment, the bids are placed through a graphical user interface. After a duration (a set period of time), which is established prior to the auction, the auction closes (step 311). In some instances, an auction may close earlier than the previously-scheduled closing date if the seller 20 has established a fixed price that will be accepted for the asset and prefers to end the auction once a bid meeting the fixed price is received. At this point, the bids may be reviewed by bidding agents of the exchange entity (step 312). At step 313, the bid results are verified, winners determined, and appropriate information given to a settlement company. Transactions may be consummated by the exchange system operator, managing the completion of the transactions. The buyer 28 (in this case, the winning bidder) receives title and the sellers 20 receive the proceeds of the sale. The exchange operator can provide further service to the buyer 28 after the auction is complete. Buyers 28 may be provided access to services that they require to manage their purchased assets. For example, a collection agency may be provided to collect the monthly service fees due on the property. In addition, the sellers 20 may continue to use the system to resell and/or relist unsold or additional inventory. Finally, at step 317, the exchange entity monetizes the transactions and solicits feedback from all participants. The transactions may be monetized by charging a flat fee per closed loan, by charging a success fee of a set percentage of the sale price, by charging a participant subscription fee plus a success fee on the price achieved over some baseline (e.g., par) value, or by any other method.

In addition to the auction bidding method, the present invention provides a bid/ask method of bidding. This method is similar to normal exchange functionality where a seller 20 places an “ask” (i.e., asking price) and bidders 28 can “hit the ask” and instantly close the sale or, conversely, can place a bid which may be considered by the seller 20. Bids may be placed and remain active for a minimum of 24 hours. Sellers 20 may hit bids at any time. This manner of sale is better suited for performing and newly originated loans and is advantageous for sellers 20 in firm pricing and par situations and could theoretically allow them to achieve liquidity in a much shorter timeframe.

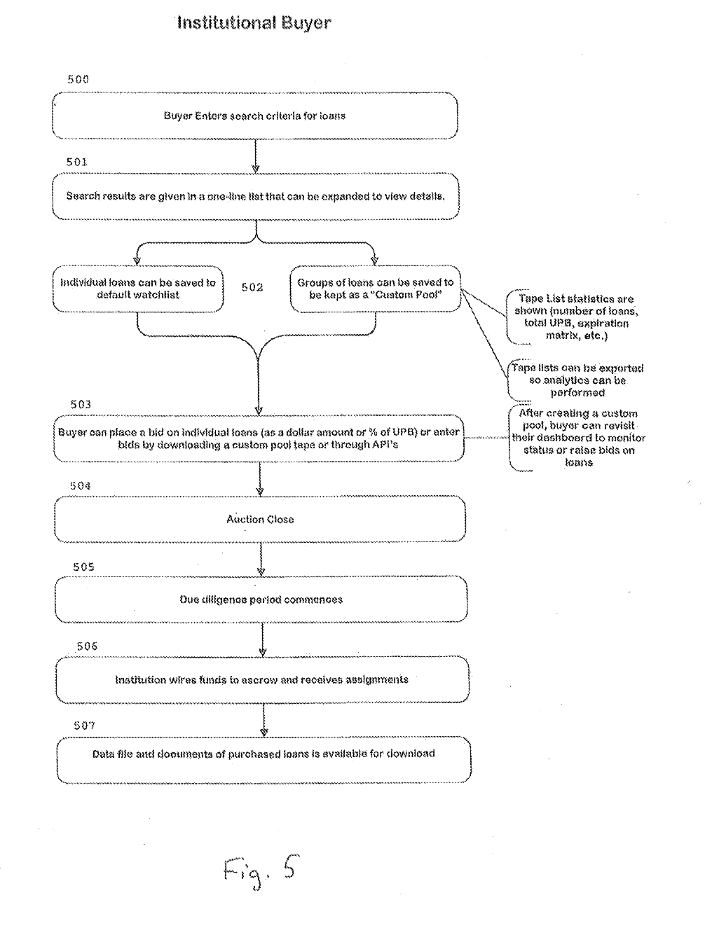

Referring now to FIG. 5, a bidding process for an institutional buyer is shown that utilizes a custom tape list, which may be referred to as a custom pool within the exchange marketplace. A “tape” or “custom pool” is a collection of assets chosen by a bidder 28 that is saved as a list in a file. These assets are usually those that the bidder 28 would like to consider purchasing. The custom pool (tape) shows the individual characteristics and data for each loan in the list, including the number of loans, total Unpaid Principle Balance (UPB) for each asset, characteristics and information about the borrower and collateral and expiration matrix, etc. Groups of loans may be saved inside the exchange system 34 (e.g., on a data storage unit connected to an exchange server 24a and/or web server 24b, or connected to a single server 24 that serves multiple functions) to be kept as one or more custom pools. In addition, the custom pool (tape) may be exported from the exchange system 34 as a text or XML formatted file, or other type of data file, in order for analytics to be performed. For example, when a bidder 28 is completing a bid sheet, they can bid on multiple assets from the exchange. The bidder 28 can create value by selecting assets via the auction platform. Bidders 28 can then download, organize, and analyze the information 35 related to those assets. Specific bid values can be associated to items in the tape and then uploaded to a server 24 using the custom pool (tape list) from a bidder's computer 30. Further, bidders 28 may be enabled to place a bid as a percentage of the UPB or as a dollar amount. The custom pool (tape list) becomes a Bid Sheet once the bidder 28 has appended bids to each asset they choose to place bids on. Multiple bids can also be placed directly from the buyer's dashboard. Individual loans can be saved inside the exchange system database 35 using a default watch list. The exchange system 34 (through a web server 24b or other means) may provide and allow interaction with these features through a web interface. In addition to this method of bidding, data may be accessed via an API and imported into a bidder's system for analysis. Bids from the resulting analysis can be uploaded to the exchange via the API. After the auction(s) close, a due diligence period may commence. Following the due diligence period, the buyer (institution) may wire funds to an escrow account and receive assignments. Then, one or more data files and documents relating to the purchased loans may be made available for download.

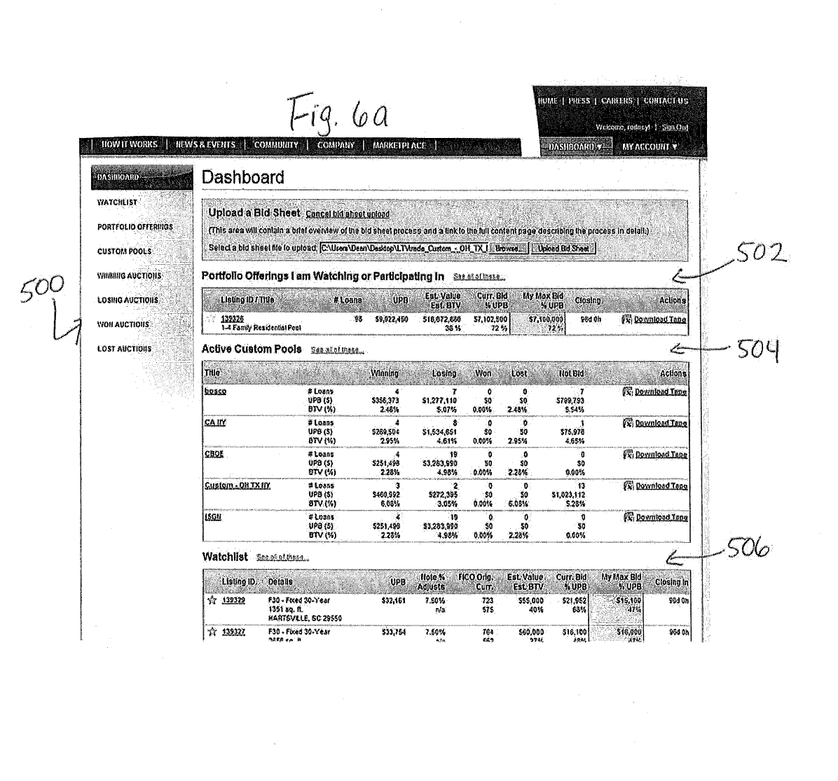

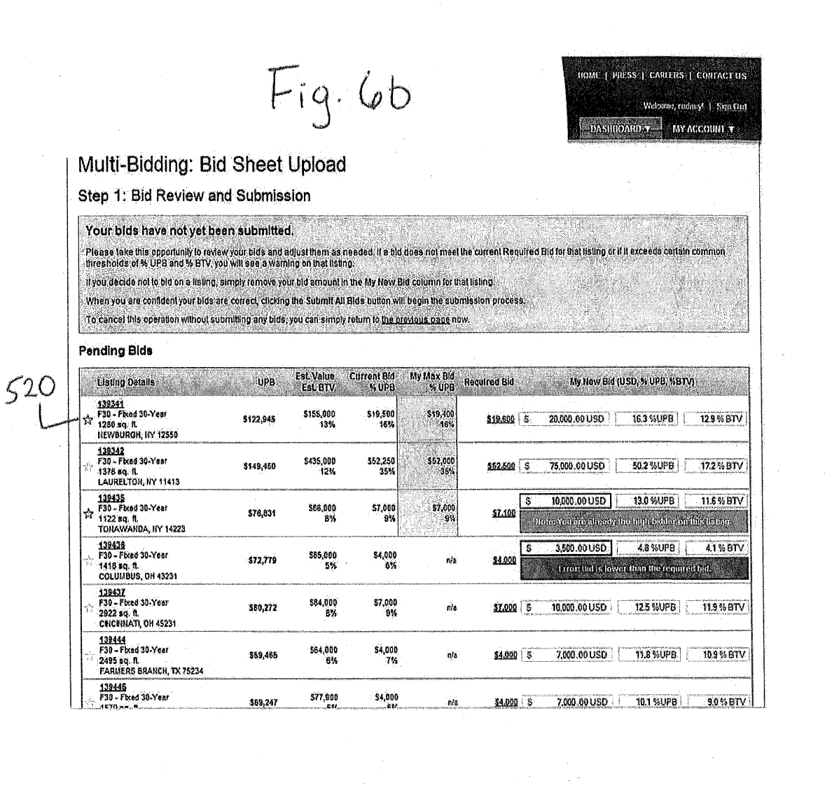

As shown in FIG. 6A, a user “Rodney” has an account in the exchange system 34 of the present invention where his information is stored. The display window includes a user dashboard 500 where information about portfolios 502, active custom pools 504, and watchlist items 506 can be tracked. The portfolios 502 shows an aggregation of all items that the user is participating in. The active custom pools 504 lists loan pools that the user is participating in, providing the number of winning and losing bids, in addition to the number of won and lost bids and not bid (i.e., loans that a bidder has added to a tape but has not made a bid on, which is the default status for loans added to a tape). In addition, the user can download a tape of the items in each pool that the user has bid on. Watchlist items 506 are represented with a customizable list of items that a user has saved. Each item in the watchlist 506 is a whole loan, and the user can see where they stand on each particular item. The user can also view buying power and the status of pending communications with exchange administrators for the invention (not shown in FIG. 6A).

The exchange system provides search capabilities to narrow the auction listings to particular criteria. Search criteria displayed to the user is dynamically generated based on user permissions and asset class. Search results may be given in a one line list that may be expanded to view details. Search results are the results that a buyer receives for a specific query that the buyer has entered. When a buyer enters search criteria for loans, the search results are generated from an auction exchange system database storing the listing items. Then, the buyer can select specific items in the search results to add to a watchlist 506. The search results may also be saved in the exchange system 34 as a custom pool and stored or exported as a tape.

In one non-limiting embodiment of the present invention, buyers can place a maximum aggregate bid amount for active auctions that equals the buyer deposit account plus a multiplier. Some buyers may be required to place funds into an escrow account to place bids. These funds help insure that the buyer will honor their bid should they win an auction. If a buyer defaults on a winning bid, they may be required to forfeit some or all of their escrow balance. A buyer's maximum aggregate amount of all outstanding bids, called Maximum Buying Power, is determined by their escrow balance multiplied by a value (margin multiplier). Initially, the margin multiplier for a buyer will be 20 times their escrow balance, but this value may be adjusted for each buyer. Some large buyers may not be subject to escrow deposit requirements or may supply letters-of-credit in lieu of escrow balances. For example, Maximum Buying Power may equal the escrow balance multiplied by the margin multiplier, and Current Buying Power may equal the escrow balance multiplied by the margin multiplier, minus any outstanding bid obligations. Each buyer profile has three fields that are maintained by an administrator of the exchange entity: escrow requirement, escrow balance, and margin multiplier. All changes to these fields must be contained in an audit log, along with the reason for the change. The escrow balance field may be true or false, depending on whether the buyer is subject to Buying Power rules. The escrow balance field may represent the current escrow balance for the buyer and, in some instances, may be updated by an administrator of the exchange entity when an auction closes or when the buyer deposits or requests withdrawals from their escrow account. The margin multiplier field represents a number that is multiplied by the escrow balance to determine a Maximum Buying Power. A buyer may increase their escrow balance by depositing funds to their third-party escrow account and notifying the exchange entity. A buyer may request a withdrawal by using a link on a dashboard provided through an interface. Buyers cannot withdraw funds if the remaining escrow balance would not create sufficient Buying Power to cover all the buyer's current bids and in settlement purchases. When placing a bid, a buyer's Buying Power is reduced by their maximum bid amount (not their current bid). For example, if a buyer places a bid on an asset for $10,000 with a maximum bid of $50,000, their Buying Power is immediately reduced by $50,000. If a buyer is increasing a bid on an auction they have previously placed a bid on, their Buying Power is reduced only by the difference between their previous maximum bid amount and the new maximum (Net Bid Increase). If a user does not have sufficient Buying Power to cover their maximum bid, an error should be presented to the user and the bid rejected.

As discussed above, buyers may also place multiple bids through a batch upload process (bid tape upload) or via a buyer dashboard/interface. In one preferred, but non-limiting embodiment, if the total of all Net Bid Increases exceeds a buyer's available Buying Power, the borrower cannot confirm all of the bids. In such a case, the buyer may be presented with a message at the top of a batch bid confirmation screen that indicates the Total Net Bid amount included in their upload, their current Buying Power, and the amount they would have to reduce their maximum bids to successfully confirm the batch. Buyers may also be presented with the option to contact the exchange entity's customer service to increase their Buying Power. Buyers can also reduce the maximum bid amounts to meet their Buying Power limits and then successfully submit their bid confirmations.

In one preferred, but non-limiting embodiment, when a buyer is outbid and becomes the second highest bidder, their Buying Power reserved for the auction may be reduced to their highest bid amount. Due to automatic incremental bidding, in most cases a losing bidder's highest bid and their maximum bid amount may be equal (in this case there is no action required). There are some situations where these values may not be equal and then the difference between the bidder's maximum bid and their highest bid is returned as Buying Power. When a buyer is no longer the first or second highest bidder on an auction, their Buying Power reserved for the auction is returned.

In a preferred, but non-limiting embodiment, when an individual bid is retracted using specified retraction rules, reserved Buying Power is also affected. The bid retraction rules may indicate which users will be the highest and second highest bidder after the retraction. The overall rule for Buying Power on auctions with a retracted bid is that no buyer's Buying Power obligation can be increased due to the retracted bid. Buying Power may be automatically adjusted by the debt marketplace engine during the bid retraction process based on a number of rules. For a buyer that was the highest bidder before retraction, the Buying Power reserved by the retracted high bid is returned to the bidder. When retracting a bid, the exchange entity (or an administrator thereof) should first lower the buyer's escrow balance or margin multiplier to reflect any escrow forfeitures related to the bid retraction. A buyer that was the second highest bidder before the retraction (and now the winning bidder), has their Buying Power reservation requirement remain the same as prior to the retraction. If they subsequently increase their current bid or maximum bid amounts (except if the bid increase is through automatic incremental bidding), they may become subject to the standard Buying Power rules again. For bidders who are the third highest or lower bidder before the retraction, those bidders will not have any Buying Power reserved even if they become the first or second highest bidder due to the retraction. If they subsequently increase their current bid or maximum bid amounts (except if the bid increase is through automatic incremental bidding), they become subject to the standard Buying Power rules again. This rule prevents issues where the new first or second highest bidder does not have enough Buying Power to cover a bid.

In one preferred, but non-limiting embodiment of the present invention, Buying Power changes may be triggered based on status changes to the related auction. For example, if the auction enters into an “in settlement” or “pending bid approval” status, winning bidders' Buying Power reserved for the auction may be reduced from their maximum bid amount to their winning bid amount, and the second highest bidder's reserved Buying Power returned. If the auction enters into an “expired” status from the “pending bid approval” status, then any Buying Power that remains reserved should be returned to all bidders. If the auction is expired because the auction has reached the Auction End Date with no bids, there is no Buying Power to return. If the auction is cancelled, all bidders have their Buying Power returned. If the auction is closed, it indicates the settlement activities to transfer ownership from the seller to the winning bidder are complete. Since a buyer may have used some of his escrow funds to complete the settlement, the exchange entity (or an administrator thereof) must review and possibly adjust the winning buyer's escrow balance to reflect any changes prior to closing an auction. Once an auction is closed, the winning bidders Buying Power that has been reserved for the auction is returned. A buyer is outbid when another buyer places a bid that exceeds the first buyers maximum bid amount. Although a buyer may be momentarily outbid by a bidder with a lower maximum bid amount, the automatic incremental bidding system will quickly set the highest bidder as the buyer with the highest maximum bid amount. When considering Buying Power calculations, the determination of highest bidder may be considered after all incremental bidding has been completed. Buyers with the highest bid and the second highest bid both have their Buying Power reserved. The highest bidder has their maximum bid amount reserved, and the second highest bidder has their highest bid amount reserved (not necessarily their maximum bid amount). The second highest bidder must have their Buying Power reserved because they are obligated to honor their bid if the highest bid is retracted prior to the Auction End Date.

In one embodiment of the present invention, a bid sheet can be used to provide multiple bid uploading facilitating the use of sophisticated valuation techniques. For example, when competing for multiple assets in an on-line auction, bidders will find value in selecting assets via the auction platform and then downloading, organizing, and further analyzing information related to those assets. The exchange system 34 provides bidders the ability to easily and independently analyze information away from the standardized software and e-tools provided by the exchange system platform. Bidders may prefer to use their own computer models using software programs, such as Excel, among others which allow for the valuation of those assets using a fully customized or “black box” approach to generate specific bid values for each asset. Once specific bid values are generated, bidders can then seamlessly upload those bids in the form of a standardized bid sheet to the on-line auction platform in an easy-to-use and efficient manner.

As shown in FIG. 6B, user Rodney has a bid sheet. The bid sheet 520 provides selectable items the bidder can select that indicate assets of interest via the on-line auction platform. The user interface can provide selectable rows or columns for the bidder to select and manipulate items. The bidder may apply the bid sheet tool which downloads the information pertaining to the selected assets and creates a custom list, such as a spreadsheet. All information pertaining to each asset can be available in one row of data and ready to analyze. The bid sheet may include a column that allows the bidder to input a maximum bid amount. The bid input methods vary by asset class and include, but are not limited to: currency amount, unpaid principal balance, and loan-to-value. Other forms of value can be applied to other asset classes in a similar fashion. In one embodiment, the bidder can select “Upload Bid Sheet” on the on-line auction platform to transfer their maximum bid values to an on-line user account. The exchange system 34 provides programming instructions to dynamically extract bids from the newly uploaded bid sheet and assign the bid values to each bid asset on behalf of the bidder. The system is not limited in providing output; these files can be manipulated on any remote system having requisite access, as well as on mobile platforms. The platform allows for disparate bidding methods, including non-monetary bidding methods, which are reconciled and compared to determine the ranking of bids placed on the auction. The ability of the exchange engine to homogenize disparate bids allows bidders to use their preferred bidding method without restricting the entire auction to one bidding method.

The bid sheet method allows bidders who apply highly sophisticated valuation techniques to participate in auctions of multiple assets. Without the bid sheet method, bidders would have no efficient way to populate their models with the necessary information to generate specific bid values. The system can adapt to other system requirements.

With continuing reference to FIG. 5, when the auction closes, it includes any bids that a buyer has placed during the auction on individual loans. The buyer can place loans as a percentage of the UPB, as a dollar amount, or as a bid to value (BTV), which is a bid as a percentage of the value of the underlying collateral (as determined by recent estimates of collateral obtained from third parties). Additional bid input methods are available based on the asset class associated with the auction. Once the auction is closed, a due diligence period begins and the due diligence process is completed. The institution wires funds to escrow and receives assignments. Then, the data file and documents for purchased loans may be made available for download.

In a real estate downturn in which loan to value ratios exceed 100%, borrowers are known to default on their mortgages both intentionally (“strategic default”) and unintentionally, and the process of foreclosing is unappealing to lenders due to the time, expense, resources, and market conditions.

In one embodiment, a loan realignment service sale can provide an effective solution for all parties involved. A loan realignment service sale is designed to simultaneously benefit three parties: seller (current lender), bidder/buyer (potential lender), and borrower (home owner). The seller's primary benefit is avoiding the cumbersome foreclosure process and having the opportunity to maximize the disposition values of troubled assets via access to a specialized pool of bidders. The bidder's benefit is the realized opportunity to profit on distressed whole loans in two ways: 1) purchasing the assets at a discount; 2) renegotiating terms to ease the borrower's liability. Renegotiation aides distressed borrowers to help them turn their nonperforming loans into a performing loan. By conforming these assets, they can then later be sold at par for profit to a Government-sponsored Enterprise (GSE) or alternative institutional buyer. A bidder can also benefit by acquiring assets for profit by foreclosure. In some cases, a bidder may desire foreclosed property, a likely inevitable fate with the current seller if the asset is not sold. In any case, the system can reduce the occurrence of foreclosure. Lastly, borrowers benefit because they may be currently in default facing foreclosure and a loan realignment service sale provides the possibility of favorable and affordable loan terms (i.e., lower principal balance and monthly payment, lower interest rates, etc.) with a new lender and, therefore, having the ability and incentive to stay in their homes.

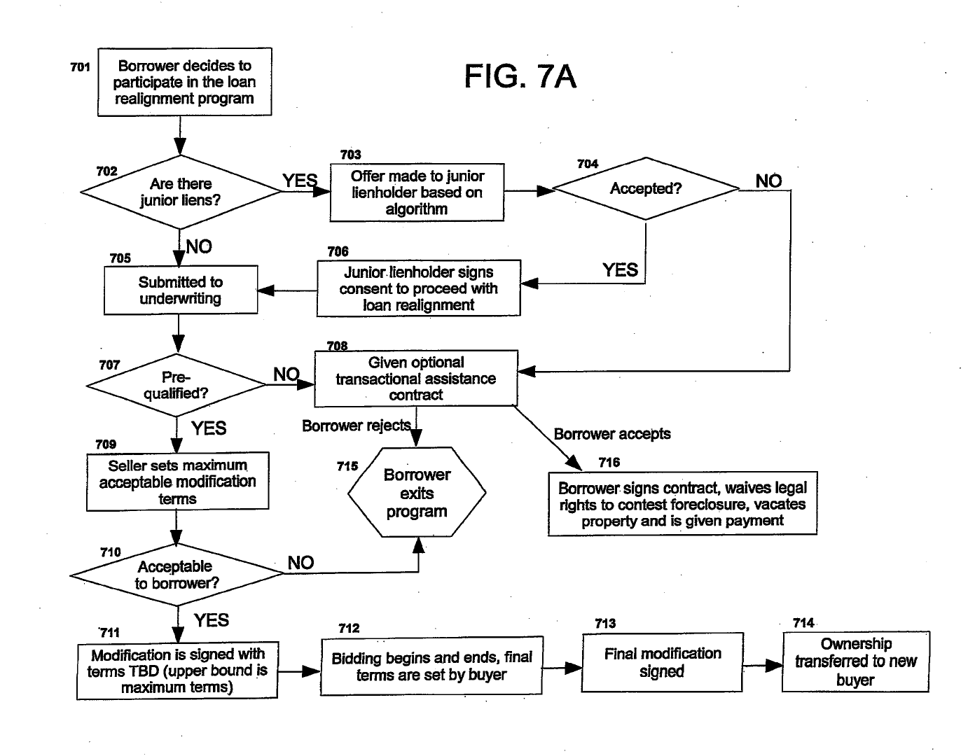

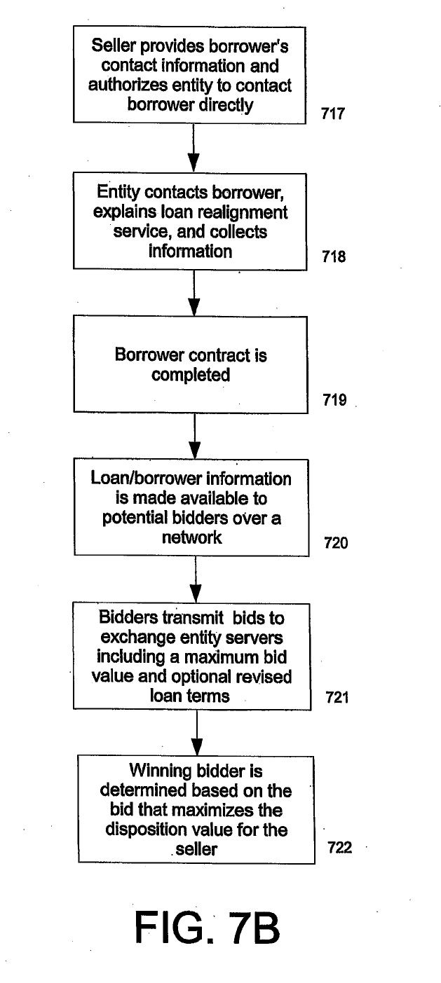

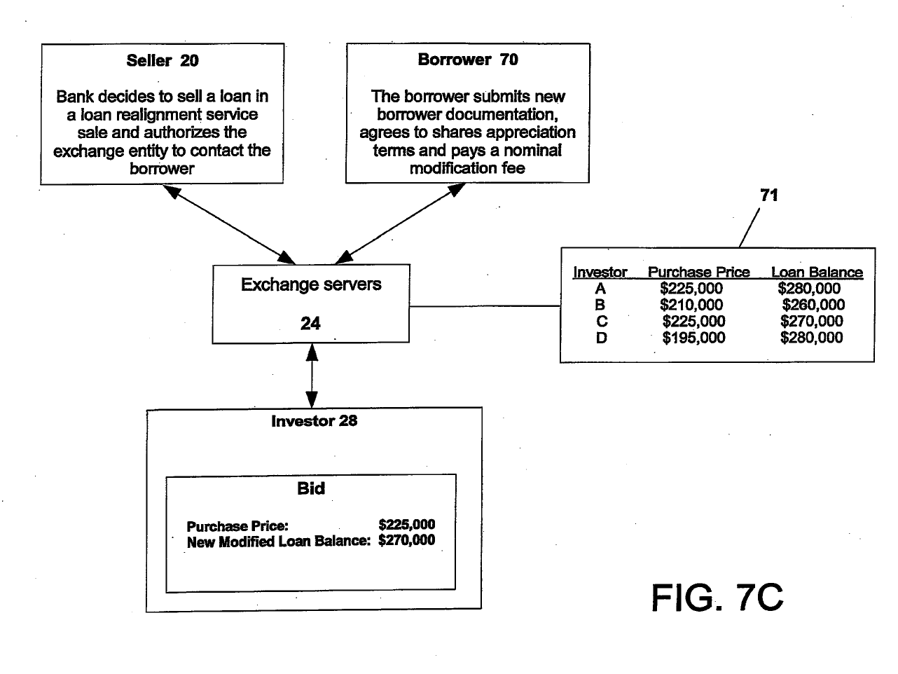

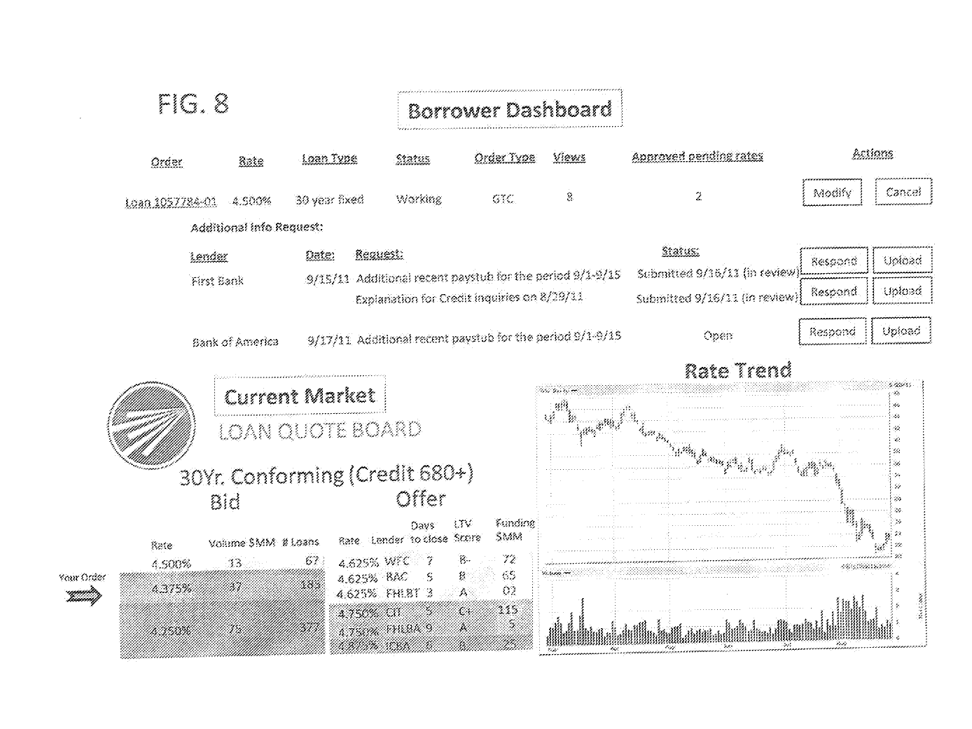

With reference to FIGS. 7B and 7C, a loan realignment service sale begins at step 717 when a seller 20 provides candidate borrower's contact information and authorizes the exchange entity to contact the borrower 70 directly to explain the loan realignment service sale opportunity. An exchange operator will explain the concept, terms, and qualification process to candidate borrowers. At step 718, system operators collect current financial qualification documentation from the borrower 70 and review the documentation. Based on collected information, a determination is made whether the borrower qualifies to participate. If the borrower qualifies and confirms an interest to participate, a signed loan realignment service sale borrower contract must be completed (step 719). At step 720, the bidders (investors) 28 are invited to review information of borrowers and to bid on “to-be-modified” distressed assets. The bidders have the benefit of reviewing the borrower's current financial situation. Such review may occur over an electronic communications medium, including, but not limited to, the Internet. Borrowers may agree to release original lender and bidders from any wrong doing prior to the modification. As a term of the modification, borrowers will agree to relieve both the original lender and the winning bidder of legacy legal risk, and bidders will also agree to relieve the legacy legal risk from the original mortgage since they have purchased the loan. At step 721, the bidder creates a bid, which includes a maximum bid value for the assets and optional revised loan terms, which will benefit the borrower. The bid which maximizes the disposition value for the seller wins the asset. In the case of a tie, the bidder/buyer who offers the most advantageous terms to the borrower wins the asset. In the example provided in FIG. 7C, bid results 71 are provided that indicate investor A and investor C both tie for the purchase price amount. In this example, because investor C has a lower loan balance, investor C is the winning bidder.

Still referring to FIG. 7C, as an example, investor D offers a purchase price of $195,000.00 and a loan balance of $280,000.00, and investor C offers a $225,000.00 purchase price and a loan balance of $270,000.00. Investor C acquires the asset because they have maximized the seller's value. If both offered equal purchase prices of $225,000.00, C would win based on loan balance. At closing, the seller receives the cash proceeds from the buyer in accordance with the winning bid. Simultaneously at closing, the newly restructured loan and contractual agreement is provided to the winning buyer/bidder. The borrower is immediately notified of their newly restructured terms and obligated to make payments to the winning bidder/buyer in accordance with the modified loan agreement.

Referring now to FIG. 7A, one preferred, but non-limiting embodiment of the loan realignment service according to the principles of the present invention, is shown. At step 701, a borrower decides to participate in the loan realignment program. As mentioned above, this participation may be initiated by a seller that currently owns the mortgage loan. At step 702, it is determined if there are any junior liens on the property subject to the mortgage. If there is a junior lien, at step 703, an offer may be made to the junior lien holder based on a predefined algorithm. At step 704, if the offer is accepted, at step 706 the junior lien holder may provide consent to proceed with the loan realignment service sale. If the junior lien holder does not accept the offer at step 704, the borrower may be given an optional transactional assistance contract, at step 708. If the borrower rejects the transactional assistance contract, at step 715 the borrower exits the program and no longer participates. If the borrower accepts the transactional assistance contract, at step 716 the borrower signs the contract, waives legal rights to contest foreclosure, vacates the property, and is given payment. Back to step 704, if the junior lien holder accepts the offer, they sign consent to proceed with loan realignment and proceed to step 705, in which the loan is subject to underwriting. At step 702, if there are no junior liens, the method proceeds to step 705 in which the loan is subject to underwriting. At step 707, it is determined whether the borrower is pre-qualified for the program. If not, the borrower may be given an optional transactional assistance contract (step 708), which may be rejected (step 715) or accepted (step 716). If the borrower is pre-qualified, the seller may set maximum acceptable modification terms at step 709. If these terms are acceptable to the borrower, at step 711 the modification is signed with terms to be determined. At step 712, the bidding begins and ends, and final terms are set by buyer. At step 713, the final modification is signed and, at step 714, ownership of the loan is transferred to the new buyer (bidder). If the terms of the modification terms at step 710 are not acceptable to the borrower, the method proceeds to step 715 in which the borrower exits the program.

In another embodiment, the Mortgage Procedural Loan Automated Negotiation (PLAN) is a technical procedure for automated and orderly term negotiation in an auction format using the exchange system. The Mortgage PLAN process allows mortgage loan “originators” (new loan lenders) and borrowers seeking mortgage financing for a new home, refinancing an existing mortgage, or financing other types of assets, to come together in an efficient technology-based forum. Borrowers benefit because they have the opportunity to possibly secure more favorable mortgage financing terms over conventional alternatives. Originators benefit because they have access to a specialized pool of borrowers that they can efficiently access, allowing them to put their capital to work at a lower cost. Furthermore, some of those savings can be passed onto the borrower in the form of more favorable terms.

In the exchange system, an example borrower (or borrower's agent) requests initial terms (e.g., a $200,000 loan with a 30 year fixed loan with a 6% reserve (interest) rate and no points). Standardized exchange documents can be used for any possible future transaction. One option for the borrower is to select a “Borrow Now” button associated to the best available rate. This can end any auction allowing the originator to win the borrowers business immediately. For example, the borrower may select a 5.5% Borrow Now rate and receive a 5.5% to conforming loans.

Alternatively, if the action proceeds, competing bids can be placed among originators. Competing bids drive interest rates lower. For example, rates can go from 8% down to 6.25% based on competition. Again, at anytime during the auction, a bidder (originator) could end the auction by placing a 5.5% bid per the borrower's Borrow Now rate.

In a slightly different scenario, if an originator seeks to bid with the loan on the condition of modifying the loan terms, then a “direct conditional offer” can be delivered to the borrower requesting that they consider the new term(s). The new terms can be associated with a borrower in the system or e-mailed directly to the borrower via the servers for the borrower's consideration. In this example, the originator requests that their standard loan documents are used, accompanied with a 1 point origination fee in return for a 5.75% interest rate. The borrower may accept or reject this variation offer. Time duration can be enforced, such as a 24-hour consideration period. A direct bid does not compete with other originators unless the borrower accepts it. If the borrower does accept, then the direct bid is posted on the auction. The borrower has the ability to change their listing to reflect the new terms or they can choose to require competing originators to adhere to the original terms. If so, the accepted terms from the “direct conditional offer” will be transparent to all competing originator bids. The Mortgage PLAN may be used to negotiate terms between borrower and lender or between buyer and seller of an existing mortgage or loan.

This invention also provides for a method for borrowers to achieve efficient, secure, and anonymous qualification and price discovery through a central and standardized debt marketplace. This method does not qualify a borrower for financing, but rather provides anonymous introductions and forums for negotiation when a borrower's characteristics match a lender's criteria.

To become eligible to seek financing through the debt marketplace, a single application form may be provided to borrowers to fill out with qualification information. The application process is flexible and, although there are several standard questionnaires that are tailored to the borrowers' situation, the process will gather pertinent information appropriate for a lender to consider extending credit to borrowers with unique situations (i.e., a self employed borrower may be asked to submit different information than a salaried employee). In addition, borrowers may elect, in their sole discretion, to fill in additional information that may be required by some lenders. If borrowers elect not to fill in this additional information, there may be a greater likelihood that prospective lenders will request such information prior to giving an approval (see Additional Information Requests explanation below). The borrower's full application may then be supplemented with third party data (i.e., third party provided credit scores, debt, and income information) to add useful qualification data and to verify and validate the information provided by the borrower. The debt marketplace then performs a series of tests and analysis to create a “Complete Borrower Profile” for the borrower, which contains specific detailed information that is typically provided when a borrower is finalizing and closing a lending transaction. Once the Complete Borrower Profile has been created, the debt marketplace will then determine and create industry standard ratios and metrics that are commonly used by lenders to determine a borrower's eligibility and qualifications, and also add these ratios to the Complete Borrower Profile. Most of these numbers are not subjective, but rather uses actual metrics that describe the borrower's financial situation and compares them to industry standards and to a borrower's other characteristics to create ratios that would allow a lender to determine a borrower's financial health and credit worthiness. An example of this would be to create a back end ratio that is computed by taking a borrower's monthly debt obligations and dividing it by their income. In some credit markets, standardized application engines exist, such as Fannie Mae's Loan Prospector and Freddie Mac's Desktop Underwriter engine. If a borrower is seeking a home loan, such engines could be easily accessed in order to attach the results to the borrower's profile. In addition to industry standard ratios and underwriting engines, algorithms may be developed to determine creditworthiness, and the results of such algorithms may also be contained in a Complete Borrower Profile.

Much of this information may be sensitive and private (i.e., social security numbers) and may require that the information is securely stored (such as in a SAS 70 storage environment). This information may be kept completely confidential and may only be delivered to a lender at request of the borrower when pricing and loan terms have already been negotiated and agreed.

In order to allow borrowers and lenders to explore a relationship, the entity managing the debt marketplace may take a subset of the information that is collected and strip it of any sensitive and/or personally identifiable information to create a borrower's Universal Buyer Profile (UBP), which is a robust collection of qualification information that is sufficient for lenders to process an application and generate a conditional approval. The UBP allows all approved direct lenders to easily scan through a borrower's anonymous credentials to determine if they can offer borrowers a pre-approved loan based on the borrower's terms. Since there is no personally identifiable information, anonymity is maintained and the lender must present any offers through the debt marketplace. Lenders will have no means to store the contacts information or present any offers directly through other mediums to the borrower.

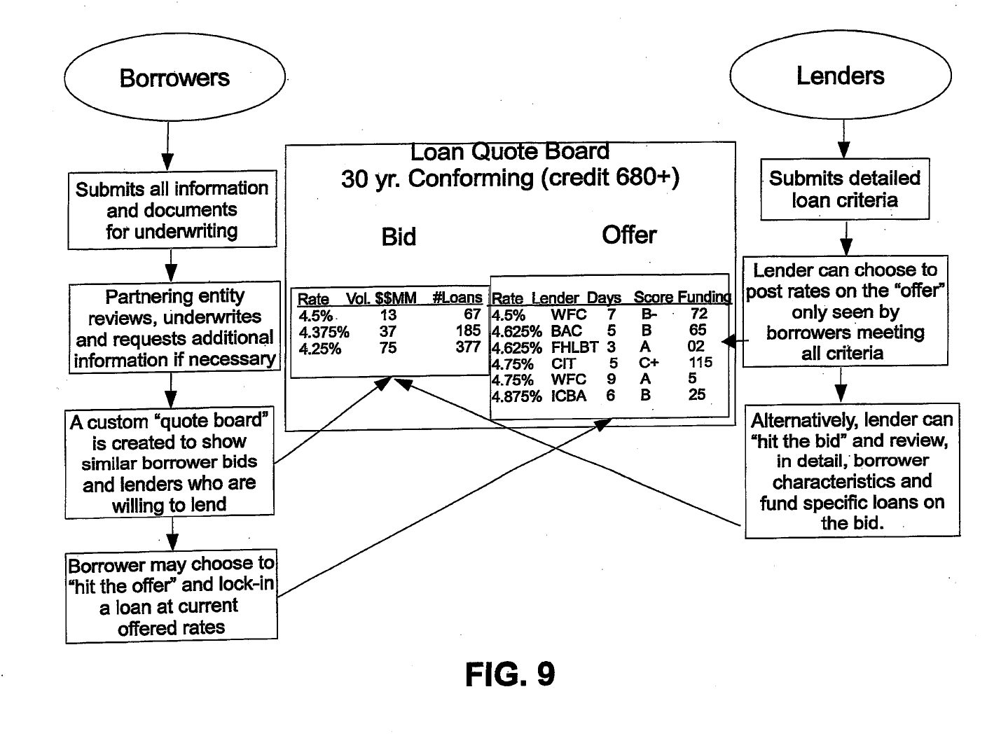

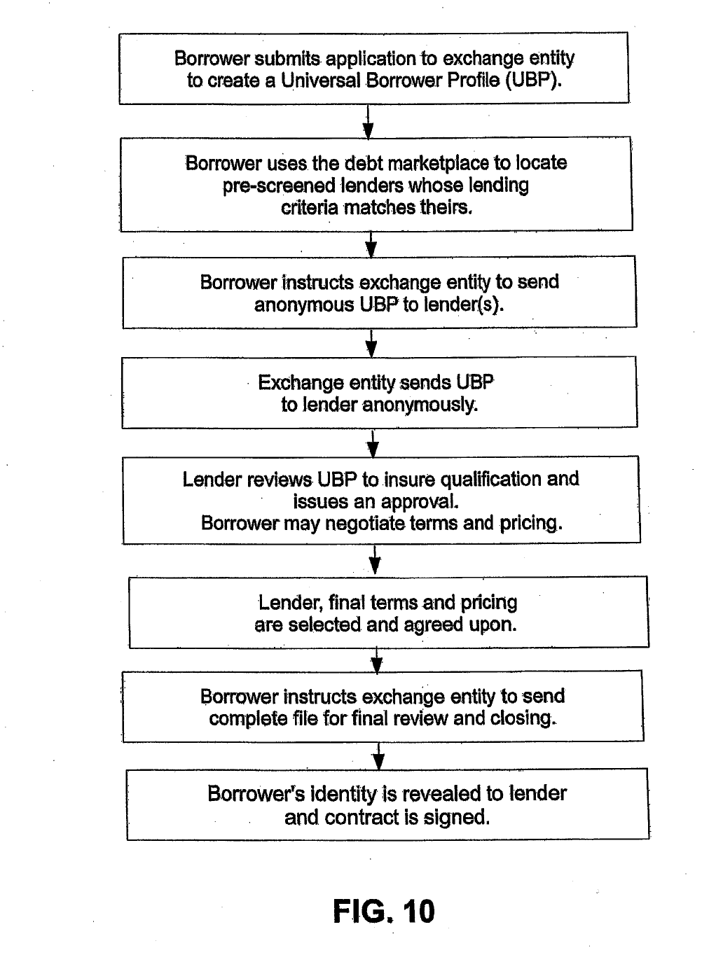

Alternatively, a UBP serves as a borrower's passport to view all lenders who have loan programs for which the borrower qualifies and is already pre-approved, as can be seen in FIG. 9. Borrowers gain access to the universe of lenders through the central and standardized debt marketplace and can negotiate with lenders directly, securely, and anonymously. UBPs can easily be downloaded and delivered to any lender the borrower chooses, without worry, by simply logging into the debt marketplace, selecting a recipient of the information and, having the marketplace work as a middleman to maintain anonymity, apply for the loan from the desired lender. Lenders respond to the inquiry by making an initial pricing offer with terms, which is then delivered directly to the borrower by the marketplace. The borrower can then anonymously negotiate with the lender on rates or terms by communicating with lenders through the debt marketplace. Negotiating better rates and comparison shopping for credit using this process is much simpler because the borrower is only subjected to a single initial underwriting and application process, is automatically shown lenders that would be willing to extend credit, and the approval and negotiation process is completely anonymous through an electronic platform, providing consumers with a more efficient approval process and an effective means of price discovery.

UBPs are created and are not attributable to any particular borrower. Although a borrower will be assigned or provided with a unique and constant (static) user ID, a UBP will not include the borrowers unique ID. Instead, a UBP ID is generated and assigned to each UBP. A listing of which borrower each UBP describes is kept completely confidential on the debt market system. Thus, if a lender were to misplace a UBP, the information would have no value to anyone, criminals included.

Each data field is given one of several designations: Sensitive—Information that is sensitive and is only included in a Full Borrower Profile. This information will never be shared with any other entity except at the request of the borrower. Once a borrower initiates this action, they will also be asked for a second confirmation method and an additional password in order to confirm their desire to share sensitive information. Sensitive information can also be categorized as “personally sensitive” or “collateral sensitive”, depending on what the information describes. A sensitive piece of information relating to the collateral would be the address of a home or the VIN number of a car.

Anonymous—Information that cannot identify the borrower. Only anonymous information can be included in a UBP.

Transaction Specific—Borrower preferences which can change with each type of transaction. This would describe the amount of credit sought, the type of credit the borrower is seeking, etc.

The following table is an example of the possible UBP data that may be sent to lenders in a standardized form (e.g., XML):

| | |
|---|---|
| UBP Unique ID-Does not identify | House 3 payment |
| borrower as each UBP has a unique | |
| identifier. Debt Marketplace retains list | |
| of all UBPs and which borrower they | |
| describe | |
| Net income | Credit score FICO |
| Gross income | Credit score FICO pull date |
| Total monthly expenses | Credit score EXP |
| Total monthly expenses | Credit score EXP pull date |
| expiring in 6 months | |
| Total monthly expenses expiring | Back end ratio-totally monthly |
| in 12 months | obligations/total income |
| House 1 payment | City/state residence |
| House 2 payment | |

In conjunction with asking the debt marketplace to distribute a UBP, a borrower must define the nature of their inquiry by filling out a questionnaire to be delivered with the UBP. For example, a UBP XML stream which defines the inquiry may have five data fields: (1) Type of credit sought: Home Loan; (2) Amount of credit sought: $250,000; (3) Will this pay off any debts on the UBP? Yes; (4) Debts to payoff: House Payment 1; (5) Notes: I need to close in 30 days, would be interested in an expeditious response.

It will be appreciated that there are several possible versions and forms of a borrower's profile. In a preferred, but non-limiting embodiment, the borrower maintains complete control over all information disseminated to lenders. In a preferred but non-limiting embodiment, the types of available profiles include a Full Borrower Profile, a Universal Borrower Profile (UBP), and a UBP+Collateral profile.

A Full Borrower Profile may contain sensitive information and documentation. When choosing to send this information, a borrower may be provided with different templates depending on the type of credit being sought. For example, applying for a credit card loan may require a different set of information than applying for a home loan may. When choosing to forward a Full Borrower Profile to a lender in order to close a loan, a borrower may customize what information is sent along.

A Universal Borrower Profile (UBP) is comprised of completely anonymous and unidentifiable information that describes a borrower's financial situation. A UBP+Collateral (UBP with collateral information) is a UBP with completely anonymous and unidentifiable information describing collateral to be used in a lending transaction. For example, if a home is being used as collateral for a mortgage, the results of an appraisal may be included with the UBP.

Matches may be determined between lenders and borrowers with a UBP. Regardless of what party initiates the anonymous interaction between a borrower and a lender, the process is a simple one to determine if the lender's requirements match with the borrower's qualifications. If the buyer chooses to explore lenders through the debt marketplace, the system will overlay the borrower's characteristics, provided by their UBP, over all lenders that publish their loan programs on the system. Conversely, the lender can choose to gain access to a set of borrowers' UBPs based on any criteria the lender sets, and the lender may then be given a list of potentially qualified candidates. In either case, this matching engine will return one of three results any time a borrower's characteristics are compared to a lender's criteria.

The first of such results is a match, wherein a borrower's characteristics are compared to a lender's criteria and every single requirement is met by the borrower. The second of such results is a non-match, wherein a borrower's characteristics are compared to a lender's criteria and one or many of the requirements does not meet the lender's standards for that program. The third type of such results may indicate that additional information is required (this result may be referred to as Additional Information Required (AIR)), since the borrower's characteristic relating to that criteria is unknown. Additional information may be required when a borrower's provided information meets all of a lender's criteria for information, but a key data point is unknown and not included in the borrower's UBP. In such a case, there could be a match, but the analysis is inconclusive or “up in the air”. If a lender receives this response when analyzing a borrower as a potential lending opportunity, they can request the additional information through the debt marketplace. Borrowers may choose to provide this data in order to continue the exploratory process, or may simply select another lender with whom they are a match. If a borrower chooses to respond to a lenders request, the borrower may choose to have the response added to their UBP, or transmitted as a one-time response.

In a non-limiting embodiment, Borrowers electing to make their UBP available to a diverse group of lenders will receive firm offers from multiple lenders. These lenders will not be able to contact them directly, as the Borrowers still remain anonymous, and the offers are delivered to the credit marketplace based on the assumption that the information contained in the UBP is true and correct. These offers will contain the interest rate, offer amount, and all of the terms, including accurate fees. Rate information, which can fluctuate often, will reflect the lenders most current pricing until a borrower selects a loan and locks that rate. Therefore, rate comparisons among multiple offers will all change as the market changes, assuming the lender has tied their rate information to an index that is an option available to lenders through the credit marketplace.

When a lender receives a UBP that is deemed to be a match for one of their loan programs, a conditional approval may be issued. Before closing, a lender may receive the Full Borrower Profile, when approved by the borrower, on which additional analysis may be performed to ensure the accuracy of the UBP. The lender shall not set additional criteria but may ask for additional information to support the validity of information included in the UBP used to create the conditional approval. Upon receiving the Full Borrower Profile, verifying the accuracy of the UBP information, the loan is closed.

Upon consummating transactions, borrowers may have the opportunity to rate lenders for their responsiveness and accuracy of the representation of the loan terms through the debt marketplace. Lenders found to be altering loan terms from those provided through the debt marketplace may be removed from advertising rates and terms. This community of borrowers will help others make knowledgeable decisions when selecting a lender and will hopefully induce lenders to maintain a high level of quality control and customer service.

The following table illustrates a non-limiting example of how introductions between borrowers and lenders may be facilitated using a Universal Borrower Profile:

| | |
|---|---|
| Step 1 | Gather Borrower data and documentation |
| Step 2 | Verify, Validate and Supplement data and documentation |
| Step 3 | Compute standard industry ratios and qualification required by |
| | lenders-determine borrower risk based on generally accepted |
| | underwriting principals |
| Step 4 | Create UBP-(borrower is anonymous) |
| Step 5 | Gather criteria, lending requirements and rate information |
| | from Lenders for loan programs |
| Step 6 | Compare UBPs to Loan program criteria and determine which |
| | borrowers qualify for or could qualify for |
| Step 7 | Borrower can choose a loan program (hit the ask) or set their |
| | own criteria and interest rate requirements (place a bid) |
| Step 8 | When a borrower accepts and selects a loan program for which |
| | they qualify or a lender accepts the borrowers rate |
| | requirements, an introduction is made. |
| Step 9 | Borrower and Lender are introduced. Lender receives the |
| | borrower's file including all documentation and analysis. |
| Step 10 | Lender verifies the completeness and correctness of the |
| | borrower's qualifications and closes the loan. Introduction is |
| | monetized. |

Lenders who choose to interact with the debt marketplace have two means to participate: active and passive participation. Active Participation—Lenders may gain access to anonymous UBPs in order to analyze and determine their desire to make an offer to lend. If a lender determines that the UBP describes a borrower they would like to pre-approve for a loan, they may make an offer by submitting the offer with the unique UBP ID and the debt marketplace will pass along the offer to the barrow's account. The borrower will receive the offer in accordance with their preferences as identified in their account. Borrower preferences can be changed by borrowers at any time and may include delivery methods with which they prefer to communicate offers on behalf of lenders.

Passive Participation (Published Offers)—Lenders can choose to publish detailed lending criteria through the debt exchange. The debt marketplace will compare the borrowers UBP to all active lenders who have published loan programs. When participating in this manner, a lender's loan program will only appear on the borrower's “credit radar” in their online dashboard if the borrower meets all of the criteria and is a “match,” or if the borrower matches all criteria but is missing some key data to be a complete match (i.e., an “Additional Information Required” offer). This allows lenders to publish loan program criteria, terms, and rates, and will serve as advertising to bring borrowers to them.

The anonymity of prospective borrowers is maintained in either of these scenarios until a point that the borrower feels comfortable enough with the lender to proactively log onto their account to request and authorize their Full Profile to be sent to the lender.

The steps to create a borrower's UBP requires active participation and the submission of much documentation and information. This process can be lengthy and is broken down into many smaller and more manageable tasks. To encourage completion and the timely submission of information, in a further non-limiting embodiment, customers will be awarded ‘points’ along the way for the timeliness and completion of tasks, which can allow them to purchase merchandise, similar to frequent flyer miles. These points may be redeemed through ‘purchases’ using a fixed number of points or by allowing participants to bid their points in an auction format to win the service or merchandise being auctioned. Additionally, or alternatively, customers can be entered into a raffle or drawing that will award a product, service, discount, or cash award through completion of tasks or use of points from the completion of tasks. Customers may elect to opt out of the points/rewards component and, if they elect to opt-in, they may have to agree to share results or make an endorsement through any number of social media platforms.

In a further non-limiting embodiment, if a borrower's UBP doesn't return any matches but the borrower has sufficient qualifications to be deserving of a loan, the borrower may elect to make their UBP available through an integrated peer to peer marketplace that allows for individuals to become lenders of a small portion of the loan balance. Individual lenders who participate will select the amount that they would like to contribute to funding the loan and the lowest return that they would accept to participate. The exchange can then aggregate bids from lenders, provide the current market return expectations in an attempt to encourage further competition, which drives down the note rate on the loan and the returns provided to the individual lenders. Once enough lenders have participated to fully fund the loan at the opening interest rate as selected by the borrower's preference and as limited to the highest rate where the loan is still affordable to the borrower, new lenders may ‘outbid’ the current lenders by submitting a lower note rate (return expectations) attached to the dollar amount of their participation.

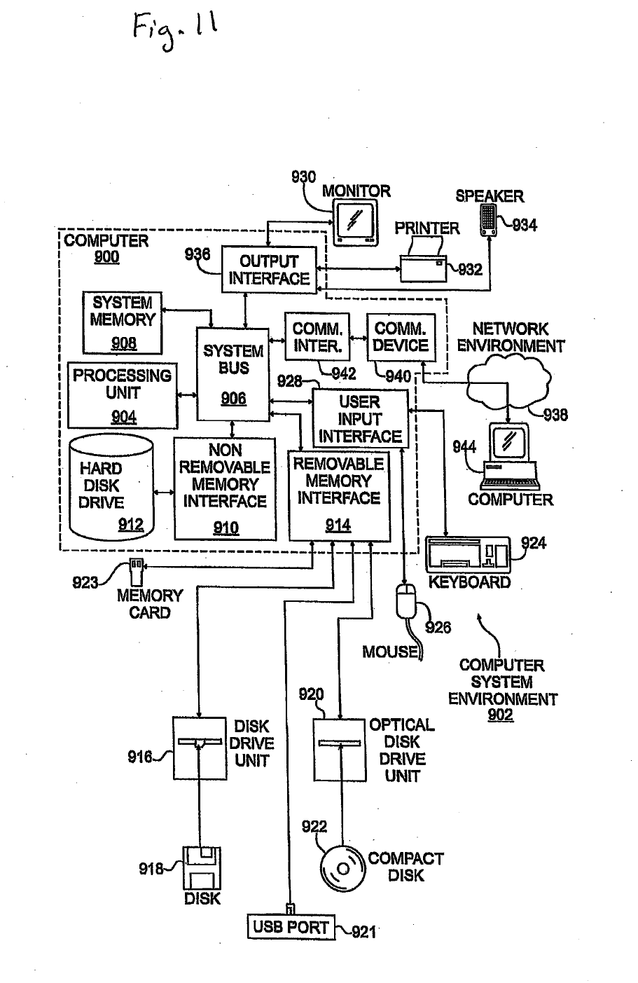

The present invention may be implemented on a variety of computing devices and systems, wherein these computing devices include the appropriate processing mechanisms and computer-readable media for storing and executing computer-readable instructions, such as programming instructions, code, and the like. As shown in FIG. 11, personal computers 900, 944, in a computing system environment 902 are provided. This computing system environment 902 may include, but is not limited to, at least one computer 900 having certain components for appropriate operation, execution of code, and creation and communication of data. For example, the computer 900 includes a processing unit 904 (typically referred to as a central processing unit or CPU) that serves to execute computer-based instructions received in the appropriate data form and format. Further, this processing unit 904 may be in the form of multiple processors executing code in series, in parallel, or in any other manner for appropriate implementation of the computer-based instructions.

In order to facilitate appropriate data communication and processing information between the various components of the computer 900, a system bus 906 is utilized. The system bus 906 may be any of several types of bus structures, including a memory bus or memory controller, a peripheral bus, or a local bus using any of a variety of bus architectures. In particular, the system bus 906 facilitates data and information communication between the various components (whether internal or external to the computer 900) through a variety of interfaces, as discussed hereinafter.

The computer 900 may include a variety of discrete computer-readable media components. For example, this computer-readable media may include any media that can be accessed by the computer 900, such as volatile media, non-volatile media, removable media, non-removable media, etc. As a further example, this computer-readable media may include computer storage media, such as media implemented in any method or technology for storage of information, such as computer-readable instructions, data structures, program modules, or other data, random access memory (RAM), read only memory (ROM), electrically erasable programmable read only memory (EEPROM), flash memory, or other memory technology, CD-ROM, digital versatile disks (DVDs), or other optical disk storage, magnetic cassettes, magnetic tape, magnetic disk storage, or other magnetic storage devices, or any other medium which can be used to store the desired information and which can be accessed by the computer 900. Further, this computer-readable media may include communications media, such as computer-readable instructions, data structures, program modules, or other data in a modulated data signal, such as a carrier wave or other transport mechanism and include any information delivery media, wired media (such as a wired network and a direct-wired connection), and wireless media (such as acoustic signals, radio frequency signals, optical signals, infrared signals, biometric signals, bar code signals, etc.). Of course, combinations of any of the above should also be included within the scope of computer-readable media.

The computer 900 further includes a system memory 908 with computer storage media in the form of volatile and non-volatile memory, such as ROM and RAM. A basic input/output system (BIOS) with appropriate computer-based routines assists in transferring information between components within the computer 900 and is normally stored in ROM. The RAM portion of the system memory 908 typically contains data and program modules that are immediately accessible to or presently being operated on by processing unit 904, e.g., an operating system, application programming interfaces, application programs, program modules, program data, and other instruction-based computer-readable codes.

With continued reference to FIG. 11, the computer 900 may also include other removable or non-removable, volatile or non-volatile computer storage media products. For example, the computer 900 may include a non-removable memory interface 910 that communicates with and controls a hard disk drive 912, i.e., a non-removable, non-volatile magnetic medium; and a removable, non-volatile memory interface 914 that communicates with and controls a magnetic disk drive unit 916 (which reads from and writes to a removable, non-volatile magnetic disk 918), an optical disk drive unit 920 (which reads from and writes to a removable, non-volatile optical disk 922, such as a CD ROM), a Universal Serial Bus (USB) port 921 for use in connection with a removable memory card, etc. However, it is envisioned that other removable or non-removable, volatile or non-volatile computer storage media can be used in the exemplary computing system environment 900, including, but not limited to, magnetic tape cassettes, DVDs, digital video tape, solid state RAM, solid state ROM, etc. These various removable or non-removable, volatile or non-volatile magnetic media are in communication with the processing unit 904 and other components of the computer 900 via the system bus 906. The drives and their associated computer storage media discussed above and illustrated in FIG. 11 provide storage of operating systems, computer-readable instructions, application programs, data structures, program modules, program data, and other instruction-based computer-readable code for the computer 900 (whether duplicative or not of this information and data in the system memory 908).

A user may enter commands, information, and data into the computer 900 through certain attachable or operable input devices, such as a keyboard 924, a mouse 926, etc., via a user input interface 928. Of course, a variety of such input devices may be utilized, e.g., a microphone, a trackball, a joystick, a touchpad, a touch-screen, a scanner, etc., including any arrangement that facilitates the input of data, and information to the computer 900 from an outside source. As discussed, these and other input devices are often connected to the processing unit 904 through the user input interface 928 coupled to the system bus 906, but may be connected by other interface and bus structures, such as a parallel port, game port, or a universal serial bus (USB). Still further, data and information can be presented or provided to a user in an intelligible form or format through certain output devices, such as a monitor 930 (to visually display this information and data in electronic form), a printer 932 (to physically display this information and data in print form), a speaker 934 (to audibly present this information and data in audible form), etc. All of these devices are in communication with the computer 900 through an output interface 936 coupled to the system bus 906. It is envisioned that any such peripheral output devices be used to provide information and data to the user.

The computer 900 may operate in a network environment 938 through the use of a communications device 940, which is integral to the computer or remote therefrom. This communications device 940 is operable by and in communication to the other components of the computer 900 through a communications interface 942. Using such an arrangement, the computer 900 may connect with or otherwise communicate with one or more remote computers, such as a remote computer 944, which may be a personal computer, a server, a router, a network personal computer, a peer device, or other common network nodes, and typically includes many or all of the components described above in connection with the computer 900. Using appropriate communication devices 940, e.g., a modem, a network interface or adapter, etc., the computer 900 may operate within and communication through a local area network (LAN) and a wide area network (WAN), but may also include other networks such as a virtual private network (VPN), an office network, an enterprise network, an intranet, the Internet, etc. It will be appreciated that the network connections shown are exemplary and other means of establishing a communications link between the computers 900, 944 may be used.

As used herein, the computer 900 includes or is operable to execute appropriate custom-designed or conventional software to perform and implement the processing steps of the method and system of the present invention, thereby, forming a specialized and particular computing system. Accordingly, the presently-invented method and system may include one or more computers 900 or similar computing devices having a computer-readable storage medium capable of storing computer-readable program code or instructions that cause the processing unit 902 to execute, configure, or otherwise implement the methods, processes, and transformational data manipulations discussed hereinafter in connection with the present invention. Still further, the computer 900 may be in the form of a personal computer, a personal digital assistant, a portable computer, a laptop, a palmtop, a mobile device, a mobile telephone, a server, or any other type of computing device having the necessary processing hardware to appropriately process data to effectively implement the presently-invented computer-implemented method and system.

Computer 944 represents one or more work stations appearing outside the local network and bidders and sellers machines. The bidders and sellers interact with computer 900, which can be an exchange system of logically integrated components including a database server and web server. In addition, secure exchange can take place through the Internet using secure www. An e-mail server can reside on system computer 900 or a component thereof. Electronic data interchanges can be transacted through networks connecting computer 900 and computer 944. Third-party vendors represented by computer 944 can connect using EDI or www, but other protocols known to one skilled in the art to connect computers could be used.

The exchange system can be a typical web server running a process to respond to HTTP requests from remote browsers on computer 944. Through HTTP, the exchange system can provide the user interface graphics.

It will be apparent to one skilled in the relevant art(s) that the system may utilize databases physically located on one or more computers which may or may not be the same as their respective servers. For example, programming software on computer 900 can control a database physically stored on a separate processor of the network or otherwise.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise.

The invention claimed is:

1. A method for providing anonymous credit qualification and price negotiation, the method comprising:
receiving, at a server computer, at least one application for at least one borrower, the at least one application comprising qualification data relating to the at least one borrower;
supplementing the at least one application with third-party data relating to the at least one borrower;
creating, for each of the at least one borrower, a complete borrower profile comprising information relating to each of the at least one borrower; and
creating, for each of the at least one borrower, a universal borrower profile, wherein the Universal Borrower Profile comprises anonymous information selected from the complete borrower profile associated with each of the at least one borrower.

2. The method of claim 1, further comprising:
making available to a plurality of lenders, from a server computer, the Universal Borrower Profile for each of the at least one borrower;
receiving, at a server computer, an offer from at least one lender of the plurality of lenders to provide a loan to at least one borrower; and
transmitting, from a server computer, the offer to the at least one borrower.

3. The method of claim 1, further comprising:
receiving, at a server computer, information regarding at least one loan program from at least one lender;
making available to a borrower, from a server computer, a list of lenders having a loan program for which the borrower qualifies; and
receiving, at a server computer, a request from the borrower to apply for a loan with a lender from the list of lenders.

4. The method of claim 3, further comprising:
receiving, at a server computer, an initial pricing offer and terms from the lender for the borrower; and
transmitting, from a server computer, the initial pricing offer and terms to the borrower.

5. The method of claim 3, further comprising:
automatically and periodically or continuously varying the at least one initial pricing offer based at least partially on at least one market index, wherein:
the information regarding the at least one loan program includes at least one initial pricing offer; and
wherein the at least one initial pricing offer is based on the assumption that the information contained in the Universal Borrower Profile is true.

6. The method of claim 5, wherein the at least one market index is selected by the lender from a plurality of market indexes identified by an exchange manager.

7. The method of claim 5, wherein the initial pricing offer comprises an interest rate, an offer amount, a plurality of contract terms associated with the offer, and an accounting of fees that would be payable by the borrower if the offer were accepted.

8. The method of claim 3, further comprising:
after a request from the borrower to apply for a loan has been received, providing the lender with the borrower's complete borrower profile;
permitting the lender to verify the completeness and correctness of the complete borrower profile; and
requesting a payment from at least one of the borrower and the lender if the loan is closed.

9. The method of claim 1, wherein the information that comprises the complete borrower profile is categorized into at least one of the following categories: sensitive information, anonymous information, transaction-specific information, or any combination thereof.

10. The method of claim 1, wherein the Universal Borrower Profile for each of the at least one borrower comprises at least one of the following: unique identifier, net income, gross income, total monthly expenses, total monthly expenses expiring in a set period of time, payment for a house, information relating to a credit score, total monthly obligations, total income, a ratio of total monthly obligations to total income, geographic location, physical address, or any combination thereof.

11. The method of claim 2, further comprising:
determining a degree of compatibility between the at least one borrower and each of the plurality of lenders, wherein the degree of compatibility will be a match if every requirement of a lender of the plurality of lenders matches is satisfied by the at least one borrower, and wherein the degree of compatibility will be a non-match if at least one requirement of a lender of the plurality of lenders is not satisfied by the at least one borrower, and wherein the degree of compatibility is unknown if the at least one borrower has not provided information needed to determine if at least one requirement of at least one lender of the plurality of lenders is satisfied.

12. The method of claim 1, wherein:
the Universal Borrower Profile is stripped of all personally identifiable information of the borrower; and
the Universal Borrower Profile is assigned an ID number which is kept confidential in a debt market system.

13. The method of claim 1, wherein the Universal Borrower Profile further comprises anonymous information describing collateral to be used in a lending transaction.

14. The method of claim 1, wherein:
a preparation process for the at least one application is divided into a plurality of steps to be completed by the at least one borrower or an agent thereof; and
the at least one borrower or the borrower's agent is provided with at least one incentive for accomplishing at least one of the plurality of steps.

15. The method of claim 14, wherein:
the at least one incentive comprises at least one point; and
the at least one point may be used to purchase at least one good or service offered by an exchange system, bid on a good or service offered by the exchange system in an auction format.

16. The method of claim 14, wherein the at least one incentive comprises entering the at least one borrower or the borrower's agent in at least one game of chance, wherein the winner of the game of chance is provided with at least one good or service.

17. The method of claim 1, further comprising:
making available to a plurality of lenders, from a server computer, the Universal Borrower Profile for the at least one borrower through a peer-to-peer market place, wherein each of the plurality of lenders is permitted to make at least one offer comprising an amount it would like to contribute to the loan and a lowest acceptable return rate;
receiving the at least one offer at a server computer;
aggregating the at least one offer to determine an aggregate offer;
transmitting from a server computer the aggregate offer to the at least one borrower when the aggregate offer reaches an amount sufficient to fully fund the loan at an opening interest rate selected by the at least one buyer.

18. The method of claim 17, further comprising:
advertising the aggregate offer to a second plurality of lenders;
receiving from at least one of the second plurality of lenders at least a second offer comprising an amount sufficient to fully fund the loan and an interest rate that is lower than the opening interest; and
transmitting the second offer to the at least one borrower.

19. A computer-implemented method for selling and realigning loans, the method comprising:
receiving, at a server computer, a request from a seller to sell a loan owed by a borrower, wherein the loan has a loan balance;
providing, from a server computer, data relating to the loan;
receiving, at a server computer, at least one bid from at least one bidder, wherein the at least one bid includes a purchase price and a modified loan balance;
determining a winning bidder based on the purchase price; and
facilitating a transfer of the loan from the seller to the winning bidder.

20. The computer-implemented method of claim 17, wherein, if more than one of the at least one bid has equal purchase prices, the winning bidder is determined based on the modified loan balance and the purchase price.
